(19) United States
(12) Patent Application Publication
(10) Pub. No.: US 2010/0076150 A1
(43) Pub. Date: Mar. 25, 2010

(54) INKJET RECORDING LIQUID

(75) Inventor: Masao Ikoshi, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/554,933

(22) Filed: Sep. 7, 2009

(30) Foreign Application Priority Data
Sep. 19, 2008 (JP) 2008-240583

(51) Int. Cl. C09D 11/02

(52) U.S. Cl. 524/555; 106/31.13; 106/31.6; 524/592

(57) ABSTRACT

The invention provides an inkjet recording liquid containing at least water, a colorant and one or more water-soluble organic solvents. The one or more water-soluble organic solvents contains at least a water-soluble organic solvent having a viscosity of no more than 100 mPa·s at 25° C. and a solubility parameter value of less than 27.5 at a content of at least 70 weight % with respect to the total content of the one or more water-soluble organic solvents. The total content of the water-soluble organic solvent having a viscosity of no more than 100 mPa·s at 25° C. and a solubility parameter value of less than 27.5 is from 5 mass % to less than 30 mass % with respect to the total amount of the inkjet recording liquid.

### CROSS-REFERENCE TO RELATED APPLICATION

This application claims priority under 35 USC 119 from Japanese Patent Application No. 2008-240583 filed on Sep. 19, 2008, the disclosure of which is incorporated by reference herein.

### BACKGROUND OF THE INVENTION

1. Field of Invention

The invention relates to an inkjet recording liquid.

2. Description of the Related Art

An inkjet recording method is a method for recording by jetting ink droplets from each of many nozzles formed at an inkjet head, and this method has been widely utilized because of the low level of noise generated during a recording operation, because running costs are inexpensive and because a high-quality image may be recorded on various recording media.

Although various kinds of recording media for inkjet recording are available, such as plain paper, coated paper, glossy paper, OHP sheets, or back print film, low-price plain paper is usually used for business applications in a normal office environment. Examples of required properties in such an environment include reduction or suppression of a curling (warping or rounding of paper) phenomenon caused when a large amount of ink is supplied onto the paper, as well as satisfaction of ordinary requirements. It is important to reduce or suppress both curl during recording and curl caused by drying or evaporating of moisture after recording.

It is also important to suppress irregularities in formed images due to deformation of the formed images.

In relation to the above, as an ink free of image loss and irregularities, and with excellent fixing properties, an ink including a diglycerine derivative is known (see, for example, Japanese Patent Application Laid-Open (JP-A) No. 10-168373).

As a method of alleviating and suppressing curl, a method is known in which curl is suppressed by using an aqueous ink including a low polar solvent at an amount of 30% or more with respect to the total ink content by weight (see, for example, JP-A No. 2007-152873).

### SUMMARY OF THE INVENTION

However, the ink disclosed in JP-A No. 10-168373 cannot suppress the occurrence of curl, and with the ink disclosed in JP-A No. 2007-152873, storage stability tend to worsen.

The present invention provides an ink jet recording liquid that can suppress the occurrence of curl and has excellent storage stability.

Namely, the present invention provides an inkjet recording liquid comprising: water; a colorant; and one or more water-soluble organic solvents, the one or more water-soluble organic solvents comprising a water-soluble organic solvent having a viscosity of no more than 100 mPa·s at 25° C. and a solubility parameter (SP) value of less than 27.5 at a content of at least 70 weight % with respect to the total content of the one or more water-soluble organic solvents, and the total content of the water-soluble organic solvent having a viscosity of no more than 100 mPa·s at 2520 C. and a solubility parameter value of less than 27.5 being from 5 mass % to less than 30 mass % with respect to the total amount of the inkjet recording liquid.

### DETAILED DESCRIPTION OF THE INVENTION

Inkjet Recording Liquid

The inkjet recording liquid of the invention contains at least water, a colorant and one or more water-soluble organic solvents. The one or more water-soluble organic solvents contain at least a water-soluble organic solvent having a viscosity of no more than 100 mPa·s at 25° C. and a solubility parameter value of less than 27.5 at a content of at least 70 weight % with respect to the total content of the one or more water-soluble organic solvents. The total content of the water-soluble organic solvent having a viscosity of no more than 100 mPa·s at 25° C. and a solubility parameter value of less than 27.5 is from 5 mass % to less than 30 mass % with respect to the total amount of the inkjet recording liquid.

This configuration of the inkjet recording liquid of the invention may enable to suppress the occurrence of curl even if image recording with ink jet recording method is performed onto plain paper, general-purpose coated paper or the like other than inkjet paper, and may facilitate to improve storage stability of the inkjet recording liquid.

The effects of the inkjet recording liquid of the invention may be remarkable under high humidity condition (80% RH at 35° C.) as well as under low humidity condition (50% RH at 25° C.).

Water-Soluble Organic Solvent

The inkjet recording liquid of the invention contains one or more water-soluble organic solvents. The one or more water-soluble organic solvents contain at least a first water-soluble organic solvent, that is a water-soluble organic solvent having a viscosity of no more than 100 mPa·s at 25° C. and a solubility parameter value of less than 27.5, at a content of at least 70 weight % with respect to the total content of the one or more water-soluble organic solvents. The total content of the first water-soluble organic solvent is from 5 mass % to less than 30 mass % with respect to the total amount of the inkjet recording liquid. When the ink jet recording liquid of the invention contains two or more water-soluble organic solvents which respectively have a viscosity of no more than 100 mPa·s at 25° C. and a solubility parameter value of less than 27.5, the sum of the contents of the two or more water-soluble organic solvents which respectively have a viscosity of no more than 100 mPa·s at 25° C. and a solubility parameter value of less than 27.5 is 70 weight % or more with respect to the total content of all of the water-soluble organic solvents contained in the ink jet recording liquid, and the sum of the contents of the two or more water-soluble organic solvents which respectively have a viscosity of no more than 100 mPa·s at 25° C. and a solubility parameter value of less than 27.5 is from 5 mass % to less than 30 mass % with respect to the total amount of the inkjet recording liquid.

This configuration of the inkjet recording liquid of the invention may enable to effectively suppress the occurrence of curl and may effectively improve storage stability of the inkjet recording liquid.

“SP value” as described in the invention means the solubility parameter value (SP value) of a solvent, which is a value expressed by the square root of the cohesive energy of molecules. SP values are described in the Polymer Handbook (Second Edition), Chapter IV: “Solubility Parameter Values”, and the values described therein are regarded as SP values in the invention. The unit for the SP value is (MPa)^{1/2}, and the SP values given represent values at a temperature of 25° C.

When the SP value data of a solvent of interest is not described in the above reference book, the value calculated by the method described in R. F. Fedors, Polymer Engineering Science, 14, pp. 147-154 (1974) (which is incorporated herein by reference in its entirety) is used as the SP value in the invention.

Viscosity in the present invention refers to the viscosity of a solvent at 25° C.

Further, viscosity in the present invention is calculated using an RE80 Viscometer (manufactured by Toki Sangyo Co., Ltd.). An RE80 Viscometer is a conical rotor/flat-plate viscometer corresponding to an E-type viscometer, and measurement is performed using a Rotor Code No. 1 rotor and, as necessary, the rotational speed is changed in the range of from 0.5 rpm to 100 rpm.

The one or more water-soluble organic solvents contain at least a first water-soluble organic solvent, that is a water-soluble organic solvent having a viscosity of no more than 100 mPa·s at 25° C. and a solubility parameter value of less than 27.5, at a content of at least 70 weight % with respect to the total content of the one or more water-soluble organic solvents. The total content of the first water-soluble organic solvent is from 5 mass % to less than 30 mass % with respect to the total amount of the inkjet recording liquid. From the viewpoint of the effect to suppress curling, the content is preferably 80 mass % or more, and more preferably 90 mass % or more. When the content is less than 70 mass %, the effect to suppress curling may be decreased.

In the present invention, the first water-soluble organic solvent having an SP value of less than 27.5 and viscosity of no more than 100 mPa·s at 25° C. is not particularly limited as long as it has these properties. The SP value of the first water-soluble organic solvent is preferably from 16 to less than 27.5 and more preferably from 18 to 26.5 in view of the curling suppression effect. The viscosity of the first water-soluble organic solvent at 25° C. is preferably no more than 80 mPa·s and more preferably no more than 50 mPa·s in view of the curling suppression effect.

Among these, a combination of an SP value of from 18 to 26.5 and viscosity of no more than 50 mPa·s is preferable.

Specific examples (SP value; viscosity (mPa·s)) of the first water-soluble organic solvent are shown in the following; however, the present invention is not limited thereto. In parentheses following the solvent name, as in, for example, (x; y), x is the SP value of the solvent while y is the viscosity (mPa·s) of the solvent.

Dipropylene glycol (DPG) (SP value 27.14; 75)

Triethylene glycol monobutyl ether (TEGmBE) (SP value 21.11; 8.1)

Triethylene glycol monoethyl ether (TEGmEE) (SP value 21.73; 6.8)

Tripropylene glycol monomethyl ether (TPGmME) (SP value 20.4; 5.8)

Diethylene glycol monoethyl ether (DEGmEE) (SP value 22.4; 4.3)

Triethylene glycol monomethyl ether (TEGmME) (SP value 22.1; 6.4)

Tripropylene glycol (TPG) (SP value 24.7; 57.0) (for example, PP-200; trade name, manufactured by Sanyo Chemical Industries, Ltd.)

Heptaoxypropylene glycol (SP value 21.2; 70.0) (for example, PP-400; trade name, manufactured by Sanyo Chemical Industries, Ltd.)

Dioxyethylene dioxypropylene butyl ether (SP value 20.1; 11.8) (for example, 50HB-55; trade name, manufactured by Sanyo Chemical Industries, Ltd.)

1,2-hexanediol (SP value 24.14; 53.3)

The inkjet recording liquid of the present invention may further contain another water-soluble organic solvent (also referred to as a “second water-soluble organic solvent”) in addition to the first water-soluble organic solvent as long as the effect of the invention is not impaired.

There are cases when the storage properties of the recording solution are improved by inclusion of a second water-soluble organic solvent.

Examples of the second water-soluble organic solvent in the invention include:

POP (3) glyceryl ether (SP value 26.4; viscosity 900; for example, trade name: GP-250, manufactured by Sanyo Chemical Industries, Ltd.);

POP (4) diglyceryl ether (SP value 26.1; for example, trade name: SC-P400, manufactured by Sakamoto Yakuhin Kogyo Co., Ltd.);

POP (9) diglyceryl ether (SP value 22.7; for example, trade name: SC-P750, manufactured by Sakamoto Yakuhin Kogyo Co., Ltd.);

POE (20) diglyceryl ether (SP value 22.4; for example, trade name: SC-E1000, manufactured by Sakamoto Yakuhin Kogyo Co., Ltd.);

POE (40) diglyceryl ether (SP value 21.0; for example, trade name: SC-E2000, manufactured by Sakamoto Yakuhin Kogyo Co., Ltd.);

Hexaoxypropylene glyceryl ether (SP value 23.2; for example, trade name: GP-400, manufactured by Sanyo Chemical Industries, Ltd.);

Nonaoxypropylene glyceryl ether (SP value 21.7; for example, trade name: GP-600, manufactured by Sanyo Chemical Industries, Ltd.);

Heptaoxypropylene glycol (SP value 21.2; for example, trade name: PP-400, manufactured by Sanyo Chemical Industries, Ltd.);

Pentaoxyethylene pentaoxypropylene butyl ether (SP value 18.8; for example, trade name: 50HB-100, manufactured by Sanyo Chemical Industries, Ltd.);

Decaoxyethylene heptaoxypropylene butyl ether (SP value 18.8; for example, trade name: 50HB-260, manufactured by Sanyo Chemical Industries, Ltd.);

Dodecaoxyethylene dodecaoxypropylene butyl ether (SP value 18.8; for example, trade name: 50HB-400, manufactured by Sanyo Chemical Industries, Ltd.);

Dodecaoxyethylene triacontaoxypropylene butyl ether (SP value 18.7; for example, trade name: PE-62, manufactured by Sanyo Chemical Industries, Ltd.);

Pentacosaoxyethylene triacontaoxypropylene butyl ether (SP value 18.8; for example, trade name: PE-64, manufactured by Sanyo Chemical Industries, Ltd.);

Diethylene glycol diethyl ether (DEGdEE) (SP value 16.8);

Propylene glycol monoethyl ether (PGmEE) (SP value 22.3); and

Dipropylene glycol monomethyl ether (DPGmME) (SP value 21.3).

Examples of the second water-soluble organic solvent include polyhydric alcohols including glycerin, 1,2,6-hexanetriol, trimethylolpropane, and alkanediols such as ethyleneglycol, propyleneglycol, diethyleneglycol, triethyleneglycol, tetraethyleneglycol, pentaethyleneglycol, 2-butene-1,4-diol, 2-ethyl-1,3-hexanediol, 2-methyl-2,4-pentanediol, 1,2-octanediol, 1,2-pentanediol, or 4-methyl-1,2-pentanediol; alkyl alcohols having 1 to 4 carbon atoms such as ethanol, methanol, butanol, propanol or isopropanol; glycol ethers such as ethyleneglycol monomethyl ether, ethyleneglycol monoethyl ether, ethyleneglycol monobutyl ether, ethyleneglycol monomethyl ether acetate, ethyleneglycol mono-iso-propyl ether, ethyleneglycol mono-n-butyl ether, ethyleneglycol mono-t-butyl ether, or 1-methyl-1-methoxybutanol; 2-pyrrolidone, N-methyl 2-pyrrolidone, 1,3-dimethyl-2-imidazolidinone, formamide, acetamide, dimethylsulfoxide, sorbit, sorbitan, acetin, diacetin, triacetin, and sulfolane. These solvents may be used singly, or in combination of two or more thereof.

When the second water-soluble organic solvent is used for the purpose of an anti-drying agent or a wetting agent, the second water-soluble organic solvent is preferably a polyhydric alcohol, and examples thereof include glycerin, ethyleneglycol, diethyleneglycol, triethyleneglycol, propyleneglycol, dipropyleneglycol, 1,3-butanediol, 2,3-butanediol, 1,4-butanediol, 3-methyl-1,3-butanediol, 1,5-pentanediol, tetraethyleneglycol, 1,6-hexanediol, 2-methyl-2,4-pentanediol, polyethyleneglycol, 1,2,4-butanetriol, and 1,2,6-hexanetriol. These polyhydric alcohols may be used singly, or in combination of two or more thereof.

When the second water-soluble organic solvent is used for the purpose of a penetrating agent, the second water-soluble organic solvent is preferably a polyol compound. Examples of the polyol compound include aliphatic diols such as 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, 2-ethyl-1,3-hexanediol or 2,2,4-trimethyl-1,3-pentanediol. Among these compounds, 2-ethyl-1,3-hexanediol and 2,2,4-trimethyl-1,3-pentanediol are preferable.

The second water-soluble organic solvent used in the invention may be used singly, or two or more kinds thereof may be mixed and used.

There is no particular limitation to the content of water in the inkjet recording liquid of the invention, although it may be preferably from 10 weight % to 99 weight %, more preferably from 30 weight % to 80 weight %, and particularly preferably from 50 weight % to 70 weight %, with respect to the total amount of the inkjet recording liquid.

Colorant

The inkjet recording liquid of the invention contains at least one colorant (hereinafter, may be referred to as “coloring agent”). Any colorant is usable as the colorant as long as it has a function of forming an image by coloring, and examples of the colorant include a pigment, a dye and a color particle. Among these, a water-dispersible pigment is preferable.

Specific examples of the water-dispersible pigments include following (1) to (4).

(1) An encapsulated pigment, that is, a polymer emulsion formed by incorporating a pigment into polymer particles. More specifically, in the polymer emulsion, pigment particles are dispersed in water, and a resin layer formed of a hydrophilic water-insoluble resin covers the surfaces of the pigment particles and imparts hydrophilicity to the pigment particles.

(2) A self-dispersing pigment, that is, a pigment having at least one hydrophilic group on a surface thereof and exhibiting at least one of water-dispersibility and water-solubility in the absence of a dispersant. More specifically, the pigment is prepared by subjecting pigment particles (such as carbon black particles) to an oxidizing treatment so as to impart hydrophilicity to the surfaces of the pigment particles and so as to enable the pigment itself to disperse in water.

(3) A resin dispersed pigment, that is, a pigment dispersed using a water-soluble polymer compound having a weight average molecular weight of 50,000 or less.

(4) A surfactant-dispersed pigment, that is, a pigment dispersed using a surfactant.

Among these pigments, the (1) encapsulated pigment and the (2) self-dispersing pigment are preferable, and the (1) encapsulated pigment is particularly preferable.

In the following, the encapsulated pigment will be described in detail.

The resin used in the encapsulated pigment is not specifically limited, but is preferably a polymer compound that is self-dispersing or dissolvable in a mixed solvent of water and a water-soluble organic solvent and that has an anionic (acidic) group. In general, the number average molecular weight of the resin is preferably in the range of about 1000 to about 100,000, and particularly preferably in the range of about 3000 to about 50,000. The resin is preferably a resin that can dissolve in an organic solvent to form a solution. When the number average molecular weight of the resin is within the above ranges, the resin can exhibit sufficient function as a cover layer on pigment particles or as a coated layer on an ink component in an ink composition. The resin is preferably used in the form of an alkali metal salt or an organic amine salt.

The resin used for the encapsulated pigment may be, for example, a material having an anionic group, and examples thereof include thermoplastic, thermosetting, or modified resins of the following types of resin: an acrylic resin, an epoxy resin, a polyurethane resin, a polyether resin, a polyamide resin, an unsaturated polyester resin, a phenol resin, a silicone resin, a fluoropolymer compound; a polyvinyl resin such as polyvinyl chloride, polyvinyl acetate, polyvinyl alcohol or polyvinyl butyral; a polyester resin such as an alkyd resin or a phthalic acid resin; an amino resin such as a melamine resin, a melamine-formaldehyde resin, an aminoalkyd co-condensed resin, a urea formaldehyde resin, or a urea resin; and copolymers or mixtures of two or more of these resins.

Of the above resins, an anionic acrylic resin can be obtained, for example, by polymerizing, in a solvent, an acrylic monomer having an anionic group (hereinafter, referred to as an anionic group-containing acrylic monomer) and, optionally, one or more other monomers copolymerizable with the anionic group-containing acrylic monomer. Examples of the anionic group-containing acrylic monomer include an acrylic monomer having one or more anionic groups selected from the group consisting of a carboxylic group, a sulfonic acid group and a phosphonic acid group. Among these monomers, an acrylic monomer having a carboxyl group is preferable.

Examples of the acrylic monomer having a carboxyl group include acrylic acid, methacrylic acid, crotonic acid, ethacrylic acid, propylacrylic acid, isopropylacrylic acid, itaconic acid and fumaric acid. Among these monomers, acrylic acid and methacrylic acid are preferable.

An encapsulated pigment can be manufactured by a conventional physical and/or chemical method by using the above components. According to a preferable embodiment of the invention, the encapsulated pigment can be manufactured by the methods described in JP-A Nos. 9-151342, 10-140065, 11-209672, 11-172180, 10-25440, or 11-43636.

In the invention, the colorant is preferably the encapsulated pigment (water-dispersible pigment), which is a pigment obtained by dispersing a colorant by a phase-inversion method.

The phase-inversion method is a self-dispersing method (a phase-inversion emulsification method), which may include, for example, dispersing a mixture of a pigment and a water-soluble or self-dispersing resin in water; this “mixture” refers to a state in which the components in an undissolved state are mixed, or a state in which the components are dissolved and mixed, or a state including both of the above states. A more specific production method using the phase-inversion method may be similar to that described in JP-A No. 10-140065.

The self-dispersing pigment is also included in preferable examples of the colorant which can be employed in the invention. The self-dispersing pigment is a pigment in which a number of hydrophilic functional groups and/or a salt thereof (hereinafter, referred to as a dispersibility-imparting group) are directly or indirectly (via an alkyl group, an alkyl ether group, an aryl group or the like) bonded to the surfaces of particles of the pigment, so that the pigment particles can be dispersed in an aqueous medium without a dispersant. Here, the expression “dispersed in an aqueous medium without a dispersant” indicates a state in which the pigment particles are dispersible in the aqueous medium even when a dispersant for dispersing the pigment is not used.

An ink containing the self-dispersing pigment as a colorant does not need to contain a dispersant, which is otherwise contained for dispersing a usual pigment. Therefore, the ink containing the self-dispersing pigment is free from decrease in defoaming properties due to a dispersant, and generation of foam can hardly occur in the ink containing the self-dispersing pigment; accordingly, an ink with excellent ink jetting stability can be easily prepared.

Examples of dispersibility-imparting groups to be bonded to the surfaces of self-dispersing pigment particles include —COOH, —CO, —OH, —SO₃H, —PO₃H₂, and a quaternary ammonium, and salts thereof The self-dispersing pigment can be manufactured by subjecting a pigment as a raw material to a physical or chemical treatment so as to bond (graft) a dispersibility-imparting group or an active species having a dispersibility-imparting group to the surfaces of the pigment particles.

Examples of the physical treatment include a vacuum plasma treatment. Examples of the chemical treatment include a wet oxidizing method in which surfaces of pigment particles are oxidized by an oxidizing agent in water and a method in which p-aminobenzoic acid is bonded to surfaces of pigment particles whereby a carboxyl group is linked to the pigment particles through the phenyl group of p-aminobenzoic acid.

In the invention, preferable examples of the self-dispersing pigment include a self-dispersing pigment whose surface has been subjected to an oxidation treatment with a hypohalous acid and/or hypohalite and a self-dispersing pigment whose surface has been subjected to an oxidation treatment with ozone. Commercially available products may also be used as the self-dispersing pigment. Examples thereof include, MICROJET CW-1 (trade name, manufactured by Orient Chemical Industry), and CAB-O-JET200 and CAB-O-JET300 (both trade names, manufactured by Cabot Corporation).

Pigment

The pigment used in the invention is not specifically limited, and may be appropriately selected depending on the purposes. For example, the pigment may be either an organic pigment or an inorganic pigment, or both.

Examples of the organic pigment include azo pigments, polycyclic pigments, dye chelates, nitro pigments, nitroso pigments and aniline black. In particular, azo pigments and polycyclic pigments are preferable.

Examples of the azo pigments include an azo lake pigment, an insoluble azo pigment, a condensed azo pigment, and a chelate azo pigment.

Examples of the polycyclic pigments include a phthalocyanine pigment, a perylene pigment, a perynone pigment, an anthraquinone pigment, a quinacridone pigment, a dioxazine pigment, an indigo pigment, a thioindigo pigment, an isoindolinone pigment, and a quinophthalone pigment.

Examples of the dye chelates include basic dye chelate pigments and acid dye chelate pigments.

Examples of the inorganic pigments include titanium oxide, iron oxide, calcium carbonate, barium sulfate, aluminum hydroxide, barium yellow, cadmium red, chrome yellow, and carbon black. Among these pigments, carbon black is particularly preferable. The carbon black may be, for example, a carbon black manufactured by a known method such as a contact method, a furnace method or a thermal method.

Examples of black pigments include carbon blacks such as RAVEN 7000, RAVEN 5750, RAVEN 5250, RAVEN 5000 ULTRAII, RAVEN 3500, RAVEN 2000, RAVEN 1500, RAVEN 1250, RAVEN 1200, RAVEN 1190 ULTRAII, RAVEN 1170, RAVEN 1255, RAVEN 1080, RAVEN 1060 or RAVEN700 (trade names, manufactured by Columbian Chemicals Co.); REGAL 400R, REGAL 330R, REGAL 660R, MOGUL L, BLACK PEARLS L, MONARCH 700, MONARCH 800, MONARCH 880, MONARCH 900, MONARCH 1000, MONARCH 1100, MONARCH 1300 or MONARCH 1400 (trade names, manufactured by Cabot Corporation); COLOR BLACK FW1, COLOR BLACK FW2, COLOR BLACK FW2V, COLOR BLACK 18, COLOR BLACK FW200, COLOR BLACK S150, COLOR BLACK S160, COLOR BLACK S170, PRINTEX 35, PRINTEX U, PRINTEX V, PRINTEX 140U, PRINTEX 140V, SPECIAL BLACK 6, SPECIAL BLACK 5, SPECIAL BLACK 4A or SPECIAL BLACK 4 (trade names, manufactured by Degussa); No. 25, No. 33, No. 40, No. 45, No. 47, No. 52, No. 900, No. 2200B, No. 2300, MCF-88, MA600, MA7, MA8 or MA100 (trade names, manufactured by Mitsubishi Chemical Corporation). However, in the invention, the black pigments are not limited thereto.

Organic pigments usable in the invention include yellow ink pigments such as C. I. Pigment Yellow 1, 2, 3, 4, 5, 6, 7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, 155 or 180.

Organic pigments usable in the invention further include magenta ink pigments such as C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53:1, 53, 55, 57 (Ca), 57:1, 60, 60:1, 63:1, 63:2, 64, 64:1, 81, 83, 87, 88, 89, 90, 101 (iron oxide red), 104, 105, 106, 108(cadmium red), 112, 114, 122 (quinacridone magenta), 123, 146, 149, 163, 166, 168, 170, 172, 177, 178, 179, 184, 185, 190, 193, 202, 209, 219, 269 or C.I. pigment violet 19. Among these pigments, C.I. pigment red 122 is particularly preferable.

Organic pigments usable in the invention further include cyan ink pigments such as C.I. Pigment Blue 1, 2, 3, 15, 15:1, 15:2, 15:3, 15:34, 16, 17:1, 22, 25, 56, 60, C.I. Bat Blue 4, 60 or 63. Among these pigments, C. I. Pigment Blue 15:3 is particularly preferable.

The pigment may be used singly or in combination of two or more thereof, each of which may be selected from the above classes of pigments and may belong to the same class as each other or different classes from each other.

Dispersant

In the invention, the dispersant used in an encapsulated pigment or a resin dispersed pigment may be selected from a nonionic compound, an anionic compound, a cationic compound, or an amphoteric compound.

The dispersant is, for example, a copolymer formed from monomers having an α, β-ethylenic unsaturated group. Examples of the monomers having an α, β-ethylenic unsaturated group include ethylene, propylene, butene, pentene, hexene, vinyl acetate, allyl acetate, acrylic acid, methacrylic acid, crotonic acid, a crotonic acid ester, itaconic acid, an itaconic acid monoester, maleic acid, a maleic acid monoester, a maleic acid diester, fumaric acid, a fumaric acid monoester, vinyl sulfonic acid, styrene sulfonic acid, sulfonated vinyl naphthalene, vinyl alcohol, acrylamide, methacryloxy ethyl phosphate, bismethacryloxyethyl phosphate, methacryloxyethylphenyl acid phosphate, ethyleneglycol dimethacrylate, diethyleneglycol dimethacrylate, styrene, styrene derivatives such as α-methyl styrene or vinyltoluene; vinyl cyclohexane, vinyl naphthalene, vinyl naphthalene derivatives, an alkyl acrylate which may have an aromatic substituent, phenyl acrylate, an alkyl methacrylate which may have an aromatic substituent, phenyl methacrylate, a cycloalkyl methacrylate, an alkyl crotonate, a dialkyl itaconate, a dialkyl maleate, vinyl alcohol, and modified compounds of any of the above compounds.

A homopolymer formed by polymerization of one kind of monomer having an α, β-ethylenic unsaturated group, which may be selected from the above monomers, or a copolymer formed by copolymerization of plural kinds of monomer having an α, β-ethylenic unsaturated group, each of which may be selected from the above monomers, may be used as a polymer dispersant.

Examples of the polymer dispersant include an alkyl acrylate-acrylic acid copolymer, an alkyl methacrylate-methacrylic acid copolymer, a styrene-alkyl acrylate-acrylic acid copolymer, a styrene-phenyl methacrylate-methacrylic acid copolymer, a styrene-cyclohexyl methacrylate-methacrylic acid copolymer, a styrene-styrene sulfonic acid copolymer, a styrene-maleic acid copolymer, a styrene-methacrylic acid copolymer, a styrene-acrylic acid copolymer, a vinyl naphthalene-maleic acid copolymer, a vinyl naphthalene-methacrylic acid copolymer, a vinyl naphthalene-acrylic acid copolymer, polystyrene, a polyester, and polyvinyl alcohol.

The dispersant used in the invention preferably has a weight-average molecular weight of from 2000 to 60,000. The ratio of the addition amount of the dispersant to the pigment is preferably from 10 weight % to 100 weight %, more preferably from 20 weight % to 70 weight % and still more preferably from 40 weight % to 50 weight %, with respect to the total amount of the pigment.

The content of the colorant is preferably from 0.1 weight % to 15 weight %, and more preferably from 1 weight % to 10 weight % with respect to the total amount of the inkjet recording liquid of the invention, in consideration of image density and image storage stability.

Surfactant

The inkjet recording liquid of the invention may contain at least one surfactant. By adding the surfactant, the surface tension of the inkjet recording liquid can be adjusted. Any of a nonionic surfactant, a cationic surfactant, an anionic surfactant or a betaine surfactant can be used. In order for the ink of the invention to be satisfactorily applied by an inkjet system, the addition amount of the surfactant is such an amount that the surface tension of the inkjet recording liquid of the invention at 25° C. is adjusted preferably to a range of from 20 mN/m to 60 mN/m, more preferably from 20 mN/m to 45 mN/m, and still more preferably from 25 mN/m to 40 mN/m.

A compound having a structure in which a hydrophilic moiety and a hydrophobic moiety are included in the molecule thereof can be effectively used as the surfactant employed in the invention. Any of an anionic surfactant, a cationic surfactant, an amphoteric surfactant, or a nonionic surfactant can be used. Furthermore, the above-mentioned polymer substance (polymer dispersant) is also usable as a surfactant.

Examples of the anionic surfactant include sodium dodecylbenzene sulfonate, sodium lauryl sulfate, a sodium alkyl diphenyl ether disulfonate, a sodium alkylnaphthalene sulfonate, a sodium dialkyl sulfosuccinate, sodium stearate, potassium oleate, sodium dioctylsulfosuccinate, a sodium polyoxyethylene alkyl ether sulfate, a sodium polyoxyethylene alkylphenyl ether sulfate, sodium dialkylsulfosuccinate, sodium stearate, sodium oleate, and sodium t-octylphenoxyethoxy-polyethoxyethyl sulfate. The surfactant may be used singly, or in combination of two or more thereof.

Examples of the nonionic surfactant include polyoxyethylene lauryl ether, polyoxyethylene octyl phenyl ether, polyoxyethylene oleyl phenyl ether, polyoxyethylene nonyl phenyl ether, oxyethylene-oxypropylene block copolymer, t-octyl phenoxyethyl polyethoxyethanol, and nonylphenoxyethyl polyethoxyethanol. The nonionic surfactant may be used singly, or in combination of two or more thereof.

Examples of the cationic surfactant include a tetraalkyl ammonium salt, an alkylamine salt, a benzalkonium salt, an alkylpyridinium salt, and an imidazolium salt. Specific examples include dihydroxyethyl stearylamine, 2-heptadecenyl-hydroxyethyl imidazoline, lauryldimethyl benzyl ammonium chloride, cetyl pyridinium chloride, and stearamide methylpyridium chloride.

The addition amount of surfactant to be added to the inkjet recording liquid of the invention is not specifically limited, but is preferably from 1 weight % or more, more preferably from 1 to 10 weight %, and even more preferably from 1 to 3 weight % with respect to the total amount of the inkjet recording liquid.

Polymer Particle

The inkjet recording liquid of the invention may contain at least one kind of polymer particles in view of improving fixing property.

Examples of the polymer particles employed in the invention include particles of a resin having an anionic group such as: a thermoplastic, thermosetting, or modified acrylic resin, an epoxy resin, a polyurethane resin, a polyether resin, a polyamide resin, an unsaturated polyester resin, a phenol resin, a silicone resin, or a fluoro resin; a polyvinyl resin such as vinyl chloride, vinyl acetate, polyvinyl alcohol, or polyvinyl butyral; a polyester resin such as an alkyd resin or a phthalic resin; an amino resin material such as a melamine resin, a melamine formaldehyde resin, an amino alkyd co-condensation resin, a urea resin, or a urea resin; or mixtures or copolymers thereof.

Among the above, the anionic acrylic resin can be obtained by polymerizing, in a solvent, acrylic monomers having an anionic group (anionic group-containing acrylic monomer) and, as required, another monomer that can be copolymerized with the anionic group-containing acrylic monomer. Examples of the anionic group-containing acrylic monomer include an acrylic monomer having at least one selected from the group consisting of a carboxyl group, a sulfonic acid group, and a phosphonic acid group. Among the above, the acrylic monomers having a carboxyl group (e.g., acrylic acid, methacrylic acid, crotonic acid, ethacrylic acid, propylacrylic acid, isopropylacrylic acid, itaconic acid, and fumaric acid) are preferable, and acrylic acid or methacrylic acid is particularly preferable.

In preferable embodiments, the polymer particles employed in the invention can be preferably self-dispersible polymer particles, and in more preferable embodiments, the polymer particles employed in the invention can be self-dispersible polymer particles having a carboxyl group, from the viewpoint of jetting (discharging) stability and stability of ink composition as liquid (particularly dispersion stability) when the pigment is used. The “self-dispersible polymer particles” refer to particles of a water-insoluble polymer that can be in a dispersion state in an aqueous medium in the absence of another surfactant by a functional group (particularly an acidic group or a salt thereof) contained in the polymer and that does not contain a free emulsifier.

The “dispersion state” can be either an emulsion state, in which the water-insoluble polymer is dispersed as a liquid in an aqueous medium, or a suspension state, in which the water-insoluble polymer is dispersed as a solid in an aqueous medium.

From the viewpoint of the aggregation rate and the fixing property when the water-insoluble polymer is employed to form the ink composition, the water-insoluble polymer used in the invention is preferably one that can be in the suspension state.

The self-dispersible polymer particles employed in the invention can be visually observed as being in the dispersion state at 25° C. for at least one week, even when the dispersion thereof is prepared by mixing and stirring, by using a stirrer having a stirring blade with number of rotations of 200 rpm for 30 minutes at 25° C., a mixture of a solution containing 30 g of the water-insoluble polymer dissolved in 70 g of organic solvent such as methyl ethyl ketone, a neutralizer which can neutralize all salt-forming groups of the water-insoluble polymer, and 200 g of water, and then removing the organic solvent from the mixture solution, although the neutralizer is either sodium hydroxide when the salt-forming group is anionic or is acetic acid when a salt-forming group is cationic.

The “water-insoluble polymer” refers to a polymer whose dissolved amount to 100 g of water at 25° C. is 10 g or lower when the polymer is dried at 105° C. for 2 hours and then dissolved in the water. The dissolved amount is preferably 5 g or lower, and more preferably 1 g or lower. The “dissolved amount” is an amount of (a part of) the water-insoluble polymer dissolved in a solvent (water) when the water-insoluble polymer is completely neutralized with sodium hydroxide or acetic acid, wherein the selection from the sodium hydroxide and the acetic acid accords to the type of the salt-forming group of the water-insoluble polymer.

The aqueous medium contains water and may further contain a hydrophilic organic solvent as required. In preferable embodiments, the aqueous medium contains water and a hydrophilic organic solvent, an amount of the hydrophilic organic solvent being in a range of 0.2 weight % or lower with respect to water, and in more preferable embodiments, the aqueous medium is substantially water.

There is no limitation on the main chain skeleton of the water-insoluble polymer. Examples include vinyl polymer and a condensed polymer (e.g., an epoxy resin, polyester, polyurethane, polyamide, cellulose, polyether, polyurea, polyimide, and polycarbonate). Among the above, vinyl polymer is particularly preferable.

Preferable examples of vinyl polymer and a monomer which configures vinyl polymer include substances disclosed in JP-A Nos. 2001-181549 and 2002-88294. Moreover, a vinyl monomer in which a dissociative group has been introduced into a terminal of a polymer by radical polymerization of a vinyl polymer using a chain transfer agent or a polymerization initiator having a dissociative group (or a substituent that can be induced to be a dissociative group) or an iniferter or by ion polymerization using a compound having a dissociative group (or a substituent that can be induced to be a dissociative group) in either an initiator or a stopper also can be used.

Preferable examples of a condensed polymer and a monomer which configures the condensed polymer include substances described in JP-A No. 2001-247787.

In preferable embodiments, the self-dispersible polymer particles employed in the invention contains a water-insoluble polymer containing a hydrophilic structural unit and a structural unit derived from an aromatic group-containing monomer from the viewpoint of self-dispersibility.

There is no limitation on the hydrophilic structural unit insofar as it is derived from a hydrophilic group-containing monomer, and may be derived from one hydrophilic group-containing monomer or may be derived from two or more hydrophilic group-containing monomers. The hydrophilic group is not limited and may be a dissociative group or a nonionic hydrophilic group.

The hydrophilic group is preferably a dissociative group, and more preferably an anionic dissociative group, from the viewpoint of promoting the self-dispersibility and improving stability of the emulsion state or dispersion state of the self-dispersible polymer particles. Examples of the dissociative group include a carboxyl group, a phosphonic acid group, and a sulfonic acid group. Among the above, the carboxyl group is preferable from the viewpoint of fixing property when the inkjet recording liquid is formed therewith.

The hydrophilic group-containing monomer is preferably a dissociative group-containing monomer from the viewpoint of self-dispersibility and aggregation properties, and specifically, the hydrophilic group-containing monomer is preferably a dissociative group-containing monomer having a dissociative group and an ethylenically unsaturated bond.

Examples of the dissociative group-containing monomer include an unsaturated carboxylic acid monomer, an unsaturated sulfonic acid monomer, and an unsaturated phosphonic acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxy methylsuccinic acid. Specific examples of the unsaturated sulfonic acid monomer include styrene sulfonic acid, 2-acrylamido-2-methyl propane sulfonic acid, 3-sulfopropyl(meth)acrylate, and bis-(3-sulfopropyl)-itaconate. Specific examples of the unsaturated phosphate monomer include vinyl phosphonic acid, vinyl phosphate, bis(methacryloxyethyl)phosphate, diphenyl-2-acryloyloxyethyl phosphate, diphenyl-2-methacryloyloxyethyl phosphate, and dibutyl-2-acryloyloxyethyl phosphate.

Among the dissociative group-containing monomers, from the viewpoint of dispersion stability and discharging stability, the unsaturated carboxylic acid monomer is preferable and acrylic acid and methacrylic acid are more preferable.

In preferable embodiments, the self-dispersible polymer particles employed in the invention contain a polymer having a carboxyl group from the viewpoint of improving self-dispersibility and an aggregation rate when the ink composition contacts a treatment liquid. In more preferable embodiments, the self-dispersible polymer particles employed in the invention contain a polymer having a carboxyl group and an acid value (mgKOH/g) of 25 to 100. In further preferable embodiments, the acid value is from 25 to 80, and in particularly preferable embodiments, the acid value is from 30 to 65, from the viewpoint of improving self-dispersibility and an aggregation rate when the ink composition contacts a treatment liquid.

Stability of the dispersion state of the self-dispersible polymer particles can be favorable when the acid value is 25 or more, and the aggregation properties can be improved when the acid value is 100 or lower.

There is no limitation on the aromatic group-containing monomer insofar as it is a compound containing an aromatic group and a polymerizable group. The aromatic group may be a group derived from an aromatic hydrocarbon or a group derived from an aromatic heterocyclic ring. In embodiments, the aromatic group is preferably an aromatic group derived from an aromatic hydrocarbon from the viewpoint of particle shape stability in an aqueous medium.

The polymerizable group may be a condensation polymerizable group or an addition polymerizable group. In embodiments, from the viewpoint of particle shape stability of the self-dispersible polymer particles in the aqueous medium, the polymerizable group preferably an addition polymerizable group, and more preferably a group containing an ethylenically unsaturated bond.

The aromatic group-containing monomer employed in the invention is preferably a monomer having an ethylenically unsaturated bond and an aromatic group derived from aromatic hydrocarbon. The aromatic group-containing monomers may be used singly or in combination of two or more.

Examples of the aromatic group-containing monomer include phenoxyethyl(meth)acrylate, benzyl(meth)acrylate, phenyl(meth)acrylate, and a styrene monomer. Examples which are preferable from the viewpoint of well-balancing hydrophilicity and hydrophobicity of the polymer chain of the self-dispersible polymer particles and ink fixing property include an aromatic group-containing (meth)acrylate monomer. Specifically, phenoxyethyl(meth)acrylate, benzyl(meth)acrylate, and phenyl(meth)acrylate are more preferable, and phenoxyethyl(meth)acrylate and benzyl(meth)acrylate are further preferable.

The “(meth)acrylate” refers to acrylate or methacrylate.

In preferable embodiments, the self-dispersible polymer particles employed in the invention contains a structural unit derived from the aromatic group-containing (meth)acrylate monomer, the content of which being from 10 weight % to 95 weight % with respect to the total amount of the water-insoluble polymer which forms the self-dispersible polymer particles. When the content of the aromatic group-containing (meth)acrylate monomer is from 10 weight % to 95 weight %, self-emulsifying property or stability of the dispersion state improves to thereby suppress an increase in ink viscosity.

In embodiments, the content of the aromatic group-containing (meth)acrylate monomer is more preferably from 15 weight % to 90 weight %, more preferably from 15 weight % to 80 weight %, and particularly preferably from 25 weight % to 70 weight %, from the viewpoint of improvement in self-emulsifying property or stability of the dispersion state, stabilization of the particle shape in an aqueous medium due to hydrophobic interaction of aromatic rings, and reduction in the amount of water-soluble components via appropriate hydrophobilyzation of particles.

The self-dispersible polymer particles employed in the invention can be formed by using, for example, a structural unit derived from the aromatic group-containing monomer and a structural unit derived from the dissociative group-containing monomer. The self-dispersible polymer particles may further contain other structural units.

While there is no limitation on a monomer which forms the other structural unit insofar as it can be copolymerized with the aromatic group-containing monomer and the dissociative group-containing monomer, from the viewpoint of flexibility of the main chain skeleton of the water-insoluble polymer or ease of regulation of glass transition temperature (Tg), an alkyl group-containing monomer is preferable.

Examples of the alkyl group-containing monomer include alkyl(meth)acrylates, such as methyl(meth)acrylate, ethyl(meth)acrylate, isopropyl(meth)acrylate, n-propyl(meth)acrylate, n-butyl(meth)acrylate, isobutyl(meth)acrylate, t-butyl(meth)acrylate, hexyl(meth)acrylate, or ethylhexyl(meth)acrylate; ethylenically unsaturated monomers having a hydroxyl group, such as hydroxymethyl(meth)acrylate, 2-hydroxyethyl(meth)acrylate, 2-hydroxypropyl(meth)acrylate, 4-hydroxybutyl(meth)acrylate, hydroxypentyl(meth)acrylate, or hydroxyhexyl(meth)acrylate; dialkylamino alkyl(meth)acrylates, such as dimethylaminoethyl(meth)acrylate; N-hydroxyalkyl(meth)acrylamides, such as N-hydroxymethyl(meth)acrylamide, N-hydroxyethyl(meth)acrylamide, or N-hydroxybutyl(meth)acrylamide; and (meth)acrylamides, such as N-alkoxyalkyl(meth)acrylamides, such as N-methoxymethyl(meth)acrylamide, N-ethoxymethyl(meth)acrylamide, N-(n-, iso)butoxymethyl(meth)acrylamide, N-methoxyethyl(meth)acrylamide, N-ethoxyethyl(meth)acrylamide, or N-(n-, iso)butoxyethyl(meth)acrylamide.

The molecular weight range of the water-insoluble polymer which configures the self-dispersible polymer particles employed in the invention is, in terms of weight average molecular weight, preferably from 3,000 to 200,000, more preferably from 5,000 to 150,000, and still more preferably from 10,000 to 100,000. By adjusting the weight average molecular weight to 3,000 or more, the content of water-soluble components can be effectively reduced. By adjusting the weight average molecular weight to 200,000 or lower, stability of self-dispersibility can be increased.

The weight average molecular weight can be measured by gel permeation chromatography (GPC). HLC-8020GPC (trade name, manufactured by Tosoh Corporation)is used as GPC apparatus, three columns of TSKGEL, SUPER MULTIPORE HZ-H (trade name, manufactured by Tosoh Corporation, 4.6 mmID×15 cm), and THF (tetrahydrofuran) as an eluate. The measurement is performed using an IR detector under the conditions of a sample concentration of 0.35 weight %, a flow rate of 0.35 ml/min., an injection amount of a sample of 10 μl, and a measurement temperature of 40° C. Calibration curves are prepared by eight samples of REFERENCE SAMPLE TSK STANDARD, POLYSTYRENE (trade name, manufactured by Tosoh Corporation): “F-40”, “F-20”, “F-4”, “F-1”, “A-5000”, “A-2500”, “A-1000” and “n-propylbenzene”.

From the viewpoint of regulation of hydrophilicity and hydrophobicity of a polymer, in preferable embodiments, the water-insoluble polymer which configures the self-dispersible polymer particles employed in the invention contains a structural unit derived from the aromatic group-containing (meth)acrylate monomer (preferably a structural unit derived from phenoxyethyl(meth)acrylate and/or a structural unit derived from benzyl(meth)acrylate), wherein the content (copolymerization ratio) of the aromatic group-containing (meth)acrylate monomer is from 15 weight % to 80 weight % with respect to the total amount of self-dispersible polymer particles.

From the viewpoint of regulation of hydrophilicity and hydrophobicity of a polymer, in preferable embodiments, the water-insoluble polymer preferably contains a structural unit derived from the aromatic group-containing (meth)acrylate monomer, a structural unit derived from a carboxyl group-containing monomer, and a structural unit derived from an alkyl group-containing monomer (preferably a structural unit derived from alkyl ester of (meth)acrylic acid wherein the content (copolymerization ratio) of the aromatic group-containing (meth)acrylate monomer is from 15 weight % to 80 weight % with respect to the total amount of self-dispersible polymer particles. In more preferable embodiments, the water-insoluble polymer contains a structural unit derived from phenoxyethyl(meth)acrylate and/or a structural unit derived from benzyl(meth)acrylate, a structural unit derived from a carboxyl group-containing monomer, and a structural unit derived from an alkyl group-containing monomer (preferably a structural unit derived from alkyl ester having 1 to 4 carbon atoms of (meth)acrylic acid), wherein the content (copolymerization ratio) of the phenoxyethyl(meth)acrylate and/or a structural unit derived from benzyl(meth)acrylate is from 15 weight % to 80 weight % with respect to the total amount of self-dispersible polymer particles. In addition, the water-insoluble polymer preferably has the acid value of from 25 to 100 and the weight average molecular weight of 3,000 to 200,000, and more preferably has the acid value of from 25 to 95 and the weight average molecular weight of 5,000 to 150,000.

Hereinafter, exemplary compounds B-01 to B-19 are shown as specific examples of the water-insoluble polymer which configures the self-dispersible polymer particles, although the invention is not limited thereto. The ratio in the brackets represents the weight ratio of copolymerization components.
B-01: Phenoxyethyl acrylate/Methyl methacrylate/Acrylate copolymer (50/45/5)
B-02: Phenoxyethyl acrylate/Benzyl methacrylate/Isobutyl methacrylate/Methacrylate copolymer (30/35/29/6)
B-03: Phenoxyethyl methacrylate/Isobutyl methacrylate/Methacrylate copolymer (50/44/6)
B-04: Phenoxyethyl acrylate/Methyl methacrylate/Ethylacrylate/Acrylate Copolymer (30/55/10/5)
B-05: Benzyl methacrylate/Isobutyl methacrylate/Methacrylate copolymer (35/59/6)
B-06: Styrene/Phenoxyethyl acrylate/Methyl methacrylate/Acrylate copolymer (10/50/35/5)
B-07: Benzyl acrylate/Methyl methacrylate/Acrylate copolymer (55/40/5)
B-08: Phenoxyethyl methacrylate/Benzyl acrylate/Methacrylate copolymer (45/47/8)
B-09: Styrene/Phenoxyethyl acrylate/Butyl methacrylate/Acrylate copolymer (5/48/40/7)
B-10: Benzyl methacrylate/Isobutyl methacrylate/Cyclohexyl methacrylate/Methacrylate copolymer (35/30/30/5)
B-11: Phenoxyethyl acrylate/Methyl methacrylate/Butyl acrylate/Methacrylate copolymer (12/50/30/8)
B-12: Benzyl acrylate/Isobutyl methacrylate/Acrylate copolymer (93/2/5)
B-13: Styrene/Phenoxyethyl methacrylate/Butyl acrylate/Acrylate copolymer (50/5/20/25)
B-14: Styrene/Butyl acrylate/Acrylate copolymer (62/35/3)
B-15: Methyl methacrylate/Phenoxyethyl acrylate/Acrylate copolymer (45/51/4)
B-16: Methyl methacrylate/Phenoxyethyl acrylate/Acrylate copolymer (45/49/6)
B-17: Methylmethacrylate/Phenoxyethyl acrylate/Acrylate copolymer (45/48/7)
B-18: Methyl methacrylate/Phenoxyethyl acrylate/Acrylate copolymer (45/47/8)
B-19: Methylmethacrylate/Phenoxyethyl acrylate/Acrylate Copolymer (45/45/10)

There is no limitation on a method of producing the water-insoluble polymer which configures the self-dispersible polymer particles employed in the invention. Examples include: a method including performing emulsion polymerization in the presence of a polymerizable surfactant to covalently bind a surfactant and a water-insoluble polymer; and a method including copolymerizing a monomer mixture containing the hydrophilic group-containing monomer and the aromatic group-containing monomer by known polymerization methods such as a solution-polymerization method or a block-polymerization method. Among the polymerization methods, the solution-polymerization method is preferable, and the solution-polymerization method using an organic solvent is more preferable, from the viewpoint of an aggregation rate and droplet discharging stability when the self-dispersible polymer particles are employed in the ink composition.

From the viewpoint of an aggregation rate, it is preferable that the self-dispersible polymer particles employed in the invention contain a polymer, the polymer being synthesized in an organic solvent and having a carboxyl group (, preferably the acid value thereof being 20 to 100,), and the self-dispersible polymer particles being prepared as a polymer dispersion in which the carboxyl group of the polymer is partially or thoroughly neutralized and water serves as a continuous phase. More specifically, the production of the self-dispersible polymer particles employed in the invention preferably has synthesizing a polymer in an organic solvent and dispersing the polymer to form an aqueous dispersion in which at least a part of the carboxyl group of the polymer is neutralized.

The dispersing preferably includes the following processes (1) and (2).

Process (1): Stirring a mixture containing a polymer (water-insoluble polymer), an organic solvent, a neutralizer, and an aqueous medium; and

Process (2): Removing the organic solvent from the mixture.

The process (1) preferably includes obtaining a dispersion by dissolving the polymer (water-insoluble polymer) in an organic solvent first, gradually adding a neutralizer and an aqueous medium, and mixing and stirring the mixture. The addition of the neutralizer and the aqueous medium in a solution of the water-insoluble polymer in which the polymer has been dissolved into an organic solvent may enable to provide self-dispersible polymer particles having particle diameters which may enable to achieve higher storage stability without strong shearing force.

There is no limitation on a stirring method of the mixture, and generally-used mixing and stirring devices or, as required, dispersers such as an ultrasonic disperser or a high voltage homogenizer can be used.

Preferable examples of the organic solvent include an alcohol solvent, a ketone solvent, and an ether solvent.

Examples of the alcohol solvent include isopropyl alcohol, n-butanol, t-butanol, and ethanol. Examples of the ketone solvent include acetone, methyl ethyl ketone, diethyl ketone, and methyl isobutyl ketone. Examples of the ether solvent include dibutyl ether and dioxane. Among the solvents, the ketone solvent such as methyl ethyl ketone, and the alcohol solvent such as isopropyl alcohol are preferable. It is also preferable to use isopropyl alcohol and methyl ethyl ketone in combination in view of making the change in polarity at the time of phase inversion from an oil phase to a water phase being moderate. By using the solvents in combination, self-dispersible polymer particles that can be free from coagulation-precipitation or fusion of particles and can have high dispersion stability and fine particle diameters can be obtained.

The neutralizer is used for forming an emulsion state or a dispersion state in which the dissociative group is partially or thoroughly neutralized and the self-dispersible polymer is stabilized in water. Examples of the neutralizer which can be used when the self-dispersible polymer employed in the invention has an anionic dissociative group (e.g., a carboxyl group) as the dissociative group include basic compounds such as organic amine compounds, ammonia, or hydroxides of alkali metals. Examples of the organic amine compound include monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and tri-isopropanolamine. Examples of the hydroxides of alkali metals include lithium hydroxide, sodium hydroxide, and potassium hydroxide. Among the above, from the viewpoint of stabilization of dispersion of the self-dispersible polymer particles employed in the invention in water, sodium hydroxide, potassium hydroxide, triethylamine, and triethanolamine are preferable.

The content of the basic compound is preferably from 5 mol % to 120 mol %, more preferably from 10 mol % to 110 mol %, and still more preferably from 15 mol % to 100 mol %, with respect to 100 mol % of the dissociative groups. Stabilization of the dispersion of the particles in water can be further demonstrated when the content of the basic compound is adjusted to 15 mol % or more. Reduction in a content of the water-soluble components can be obtained when the content of the basic compound is adjusted to 100 mol % or lower.

In the process (2), an aqueous dispersion of the self-dispersible polymer particles can be obtained by inverting a phase of the dispersion, which has been obtained in the process (1), to a water phase by common procedures such as vacuum distillation distilling off the organic solvent from. The thus-obtained aqueous dispersion is substantially free of the organic solvent. The amount of the organic solvent contained in the aqueous dispersion is preferably 0.2 weight % or lower, and more preferably 0.1 weight % or lower.

The average particle diameter of the polymer particles (particularly the self-dispersible polymer particles) is, in terms of a volume average particle diameter, preferably in the range of 10 nm to 400 nm, more preferably in the range of 10 nm to 200 nm, still more preferably in the range of 10 nm to 100 nm, and particularly preferably in the range of 10 nm to 50 nm. When the average particle diameter is 10 nm or more, suitability of the polymer particles to production process may be increased. When the average particle diameter is 400 nm or lower, the storage stability may be increased. The particle size distribution of the polymer particles is not particularly limited. The polymer particles may have either a broad particle size distribution or a monodisperse particle size distribution. Two or more water-insoluble particles may be used in combination as a mixture.

The average particle diameter and particle size distribution of the polymer particles can be determined by measuring the volume average particle diameter by dynamic light scattering using a nanotruck particle size distribution meter UPA-EX150 (trade name, manufactured by Nikkiso Co., Ltd.).

From the viewpoint of glossiness of an image formed from the ink composition or the like, the content of the polymer particles (particularly the self-dispersible polymer particles) in the inkjet recording liquid is preferably from 1 weight % to 30 weight %, and more preferably 5 weight % to 15 weight %, with respect to the total amount of the inkjet recording liquid.

The polymer particles (particularly the self-dispersible polymer particles) can be used singly or in a form of a mixture of two or more thereof.

Water-Soluble Polymer Thickener

The ink jet recording liquid of the invention contains at least one water-soluble polymer thickener. The water-soluble polymer thickener used in the invention is not particularly limited, provided that it is a compound where, when it is dissolved in an aqueous solution, the viscosity of the aqueous solution is greater than that of water.

The degree of solubility of the water-soluble polymer thickener used in the invention is preferably 1 g or more with respect to 100 g of water at 25° C. The molecular weight thereof, as a weight-average molecular weight, is preferably from 2,000 to 100,000, more preferably from 4,000 to 50,000, and still more preferably from 3,000 to 50,000.

Examples of the water-soluble polymer thickener include a vinyl polymer, a polyether polymer, a polysaccharide polymer, a polyacrylate polymer, a pyrrolidone polymer, and a cellulose polymer.

Specific examples of the water-soluble polymer thickener include: gelatin, polyvinyl alcohol, various modified polyvinyl alcohols, polyvinylpyrrolidone, vinyl formal and modified compounds thereof, polyoxyalkylene glycol; acryilic polymers such as polyacrylamide, polydimethylacrylamide, polydimethylaminoacrylate, sodium polyacrylate, a salt of an acrylic acid/methacrylic acid copolymer, sodium polymethacrylate, or a salt of an acrylic acid/vinyl alcohol copolymer; natural polymers and modified compounds thereof such as starch, oxidized starch, carboxyl starch, dialdehyde starch, dextrin, sodium alginate, gum arabic, casein, pullulan, dextran, cellulose, or modified compounds of cellulose (such as methylcellulose, ethylcellulose, carboxymethylcellulose or hydroxypropylcellulose); and synthetic polymers and modified compounds thereof such as polyethylene glycol, polypropylene glycol, polyvinyl ether, polyglycerol, a maleic acid/alkylvinyl ether copolymer, a maleic acid/N-vinylpyrrole copolymer, a styrene/maleic anhydride polymer or polyethylenimine.

In particular, for jetting stability and to suppress curl, polyvinyl alcohol, polyvinylpyrrolidone, polyoxyalkylene glycol, gelatin, vinyl formals, modified compounds of any of these, acrylic polymers such as a salt of an acrylic acid/vinyl alcohol copolymer, a natural polymer and modified compounds thereof such as starch, dextrin, gum arabic, casein, pullulan, dextran, cellulose, or modified compounds of cellulose (such as methylcellulose, ethylcellulose, carboxymethylcellulose, or hydroxypropylcellulose) are preferable, and polyvinyl alcohol, polyvinylpyrrolidone, and polyoxyalkylene glycol are more preferable.

The polyoxyalkylene glycol may have a single oxyalkylene group, or may have two or more oxyalkylene groups. If the polyoxyalkylene glycol has two or more oxyalkylene glycol groups, the polyoxyalkylene glycol may be a random polymer or a block polymer.

In view of stability and to suppress curl, the water-soluble polymer thickener preferably contains at least one of polyoxyethylene glycol and a polyoxyethylene/polyoxypropylene block polymer.

In view of jetting stability and to suppress curl, the average degree of polymerization of the polyvinyl alcohol is preferably from 100 to 3500, and more preferably from 120 to 2000. For dispersion stability of the ink, the degree of saponification is preferably 50 mol % or greater, and more preferably 70 mol % or greater.

The water-soluble polymer thickener preferably has a weight average molecular weight of 2000 to 100,000 and contains at least one of polyvinyl alcohol, polyvinylpyrrolidone, polyoxyethylene glycol, and a polyoxyethylene polyoxypropylene block polymer, and more preferably has a weight average molecular weight of 3000 to 50,000 and contains at least one of polyvinyl alcohol, polyvinylpyrrolidone, polyoxyethylene glycol and a polyoxyethylene polyoxypropylene block polymer.

The water-soluble polymer thickener employed in the invention preferably contains a basic group or an acidic group.

Examples of the basic group include an amino group which may include a substituent, a quaternary ammonium group, or the like. Examples of the basic group which are particularly preferable in view of dispersion stability of the ink include an amino group.

Examples of the acidic group include a carboxyl group, a phosphate group, a phosphonate group, a sulfonic acid group, a sulfonamide group, or the like. Examples of the basic group which are particularly preferable in view of dispersion stability of the ink include a carboxyl group and a sulfonic acid group.

Other Components

The inkjet recording liquid of the invention may further contain other additives. Examples of other additives include known additives such as an ultraviolet absorber, an anti-fading agent, an antifungal agent, a pH adjuster, an antirust agent, an antioxidant, an emulsion stabilizer, an antiseptic agent, a defoaming agent, a viscosity adjustment agent, a dispersion stabilizer, a chelating agent, and a solid wetting agent.

Examples of the ultraviolet absorber include a benzophenone ultraviolet absorber, a benzotriazole ultraviolet absorber, a salicylate ultraviolet absorber, a cyanoacrylate ultraviolet absorber, and a nickel complex salt ultraviolet absorber.

As the anti-fading agent, various organic anti-fading agents and metal complex anti-fading agents can be used. Examples of the organic anti-fading agent include hydroquinones, alkoxyphenols, dialkoxyphenols, phenols, anilines, amines, indans, chromanes, alkoxy anilines, and heterocycles. Examples of the metal complex anti-fading agents include a nickel complex and a zinc complex.

Examples of the antifungal agent include sodium dehydroacetate, sodium benzoate, sodium pyridinethione-1-oxide, ethyl p-hydroxybenzoate, 1,2-benzisothiazoline-3-one, sodium sorbate, and sodium pentachlorophenol. The content of antifungal agent in the inkjet recording liquid is preferably from 0.02 to 1.00 weight %.

The pH adjuster is not specifically limited as long as the pH adjuster can adjust a pH value to a desired value without exerting an adverse influence on an inkjet recording liquid to which the pH adjuster is added. The pH adjuster may be selected appropriately in accordance with the purpose. Examples of the pH adjuster include alcohol amines (such as diethanlol amine, triethanol amine or 2-amino-2-ethyl-1,3-propanediol); alkali metal hydroxides (such as lithium hydroxide, sodium hydroxide or potassium hydroxide); ammonium hydroxides (such as ammonium hydroxide or quaternary ammonium hydroxide); phosphonium hydroxide; and alkali metal carbonates.

Examples of the antirust agent include acid sulfite, sodium thiosulfate, ammonium thiodiglycolate, diisopropyl ammonium nitrite, pentaerythritol tetranitrate, and dicyclohexyl ammonium nitrite.

Examples of the antioxidant include phenolic antioxidants (including hindered phenol antioxidants), amine antioxidants, sulfur antioxidants, and phosphorus antioxidants.

Examples of the chelating agent include sodium ethylenediamine tetraacetate, sodium nitrilotriacetate, sodium hydroxyethyl ethylenediamine triacetate, sodium diethylenetriamine pentaacetate, and sodium uramil diacetate.

Physical Properties of Inkjet Recording Liquid

The surface tension of the inkjet recording liquid of the invention at 20° C. is preferably from 20 mN/m to 60 mN/m, more preferably from 20 mN/m to 45 mN/m, and still more preferably from 25 mN/m to 40 mN/m. The surface tension may be adjusted to the desired range, for example, by containing a surfactant.

From the view point of jetting properties, the viscosity of the inkjet recording liquid of the invention at 20° C. is preferably from 5 mPa·s to 20 mPa·s, more preferably from 5.5 mPa·s to less than 18 mPa·s, and still more preferably from 6 mPa·s to less than 16 mPa·s . The viscosity of the inkjet recording liquid of the invention at 40° C. is preferably from 3 mPa·s to 15 mPa·s, more preferably from 3.5 mPa·s to less than 12 mPa·s, and still more preferably from 4 mPa·s to less than 10 mPa·s. The viscosity may be adjusted to the desired range, for example, by modifying the molecular weight and content of the water-soluble organic solvents. Since the inkjet recording liquid of the invention contains the first water-soluble organic solvent, the viscosity of the inkjet recording liquid can be adjusted to the desired range more easily.

Inkjet Recording Method

Preferable examples of an inkjet recording method employed in the invention include a method in which energy is supplied to an inkjet recording liquid to form an image on a known image receiving material such as plain paper, resin coated paper, inkjet paper as those described in JP-A Nos. 8-169172, 8-27693, 2-276670, 7-276789, 9-323475, 62-238783, 10-153989, 10-217473, 10-235995, 10-337947, or 10-217597, a film, electrophotographic common paper, fabrics, glass, metal or ceramics. In addition, as an inkjet recording method applied to the invention, the inkjet recording method described in the paragraphs [0093] to [0105] of JP-A No. 2003-306623 can be preferable.

When forming an image, a polymer latex compound may be used together for the purpose of imparting glossiness and water resistance or of improving weather-resistance. The time when the latex compound is added to the image receiving material may be before, after, or simultaneously with application of a colorant. Accordingly, the latex compound may be added to an image receiving paper or added to an ink, or may be used as an independent liquid of the polymer latex. More specifically, methods described in JP-A Nos. 2002-166638, 2002-121440, 2002-154201, 2002-144696 and 2002-080759 can be preferably used.

Preferable examples of an image forming method using the inkjet recording liquid of the invention include an inkjet recording method including the following processes of:

a first process, being a process of applying a printability-improving liquid composition onto a recording medium;

a second process, being a process of applying an inkjet recording liquid onto the recording medium onto which the liquid composition has been applied; and

other additional processes, which are not particularly limited, and may be suitably selected according to the purpose.

Examples of the additional processes include a drying/removal process and a heat fixing process. The drying/removal process is not specifically restricted as long as the ink solvent in the inkjet recording liquid that is applied to a recording medium can be dried and removed by the process, and conditions of the process may be suitably selected according to the purpose. The heat fixing process is not specifically restricted as long as resin particles contained in the inkjet recording liquid used in the inkjet recording method are fused and fixed in the process, and conditions of the process may be suitably selected according to the purpose.

Preferable examples of the image forming system using the inkjet recording liquid of the invention further include an inkjet recording method including the following processes of:

a first process, being a process of applying a printability-improving liquid composition onto an intermediate transfer medium;

a second process, being a process of applying an inkjet recording liquid onto the intermediate transfer medium onto which the liquid composition has been provided;

a third process, being a process of transferring an ink image formed on the intermediate transfer medium onto a recording medium; and

other additional processes, which are not particularly limited, and may be suitably selected according to the purpose. Examples of the additional processes include a drying/removal process and a heat fixing process.

Printability-Improving Liquid Composition

Preferable examples of the inkjet recording method using the inkjet recording liquid of the invention include an inkjet recording method including a process of applying a printability-improving liquid composition onto a recording medium.

Preferable examples of the printability-improving liquid composition include a liquid composition that, when mixed with an ink, causes aggregation by changing the pH of the ink. The pH of the liquid composition is preferably from 1 to 6, more preferably from 2 to 5, and still more preferably from 3 to 5.

A preferable example of the printability-improving liquid composition that can be used in the invention is a process liquid containing a multivalent metal salt or a polyallylamine.

The printability-improving liquid composition may include a component that causes aggregation of the pigment, and examples of the component includes a polyvalent metal salt, an organic acid, a polyallylamine, and derivatives thereof.

Examples of the polyvalent metal salt include a metal salt of any of the following: a salt of an alkaline earth metal belonging to Group 2 of the Periodic Table (for example, magnesium or calcium), a salt of a transition metal belonging to Group 3 of the Periodic Table (for example, lanthanum), a salt of a cation derived from an element belonging to Group 13 of the Periodic Table (for example aluminum), or a salt a lanthanide (for example neodymium). Preferable examples of the metal salt include a carboxylate (for example, a formate, an acetate, or a benzoate), a nitrate, a chloride, or a thiocyanate. Among them, more preferable examples include a calcium or magnesium salt of a carboxylic acid (such as formic acid, acetic acid, or benzoic acid), a calcium or magnesium salt of nitric acid, calcium chloride, magnesium chloride, and a calcium or magnesium salt of thiocyanic acid.

Preferable examples of the organic acid include polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyronecarboxylic acid, pyrrolecarboxylic acid, furancarboxylic acid, pyridinecarboxylic acid, coumalic acid, thiophenecarboxylic acid, nicotinic acid, modified compounds thereof, and salts thereof.

The component that causes aggregation of the pigment may be used singly or in combination of two or more thereof.

The content of the component that causes aggregation in the printability-improving liquid is preferably from 1 weight % to 10 weight %, more preferably from 1.5 weight % to 7 weight %, and still more preferably from 2 weight % to 6 weight %.

### EXAMPLES

Hereinafter, the invention will be described in more detail with reference to examples, but the invention is not limited to the examples. Further, “parts” and “%” are expressed in terms of weight, unless otherwise specified.

### Example 1

Preparation of Inkjet Recording Liquid

Preparation of Pigment (Colorant) Dispersion Liquid

Preparation of Polymer Dispersant P-1

Methyl ethyl ketone (88 g) was placed in a 1000 ml three-neck flask equipped with a stirrer and a condenser tube, and heated to 72° C. under a nitrogen atmosphere. Separately, 0.85 g of dimethyl-2,2′-azobisisobutyrate, 60 g of benzyl methacrylate, 10 g of methacrylic acid, and 30 g of methyl methacrylate were dissolved in 50 g of methyl ethyl ketone to form a mixed solution. The solution was added dropwise to the liquid in the flask over three hours. After the dropwise addition was completed, the reaction was further continued for one hour. Then, a solution obtained by dissolving 0.42 g of dimethyl 2,2′-azobisisobutyrate in 2 g of methyl ethyl ketone was added to the reaction solution, and the reaction solution was heated to 78° C. and heated at the temperature for 4 hours. The obtained reaction solution was reprecipitated twice with an excess quantity of hexane, and the precipitated resin was dried, whereby 96 g of dispersant P-1 was obtained.

Subsequently, the composition of the obtained resin was identified with ¹H-NMR. The weight average molecular weight (Mw) was determined by a GPC method, and found to be 44,600. Furthermore, the acid value of the polymer was obtained in accordance with the method described in JIS Standard (JIS-K0070 (1992), the disclosure of which is incorporated by reference herein), and was found to be 65.2 mg KOH/g.

Preparation of Cyan Dispersion

10 parts by weight of Pigment blue 15:3 (trade name: PHTHALOCYANINE BLUE A220, manufactured by Dainichiseika Color & Chemicals Mfg. Co., Ltd.), 5 parts by weight of the polymer dispersant P-1, 42 parts by weight of methyl ethyl ketone, 5.5 parts of an aqueous solution of NaOH (1 mol/L), and 87.2 parts of ion-exchanged water were mixed, and the mixture was dispersed by a bead mill for 2 to 6 hours using zirconia beads with a diameter of 0.1 mmφ.

Methyl ethyl ketone was removed from the obtained dispersion at 55° C. under reduced pressure, and a part of water was removed, whereby a cyan dispersion liquid with a pigment concentration of 10.2 weight % was obtained.

Thus, as a colorant, the cyan dispersion liquid was prepared.

Synthesis and Preparation of Self-Dispersible Polymer Particles

360.0 g of methyl ethyl ketone was placed in a 2 L three necked flask equipped with a stirrer, a thermometer, a reflux condenser tube, and a nitrogen gas introducing pipe, and the temperature was raised to 75° C. Thereafter, while maintaining the temperature inside the flask at 75° C., a mixed solution containing 180.0 g of phenoxyethyl acrylate, 162.0 g of methyl methacrylate, 18.0 g of acrylic acid, 72 g of methyl ethyl ketone, and 1.44 g of V-601 (trade name, manufactured by Wako Pure Chemical Ind. Ltd.) was added dropwise at a constant rate so that the dropwise addition was completed in 2 hours. After completion of the dropping, a solution containing 0.72 g of V-601 (described above) and 36.0 g of methyl ethyl ketone was added, and stirred at 75° C. for 2 hours. Further, a solution containing 0.72 g of V-601 (described above) and 36.0 g of isopropanol was added, and stirred at 75° C. for 2 hours. Thereafter, the temperature was raised to 85° C., and the stirring was continued for further 2 hours, thereby obtaining a copolymer. The weight average molecular weight (Mw) of the obtained copolymer was 64,000 (measured by GPC using three columns of TSKGEL SUPER HZM-H, TSKGEL SUPER HZ4000 and TSKGEL SUPER HZ2000 (all trade names, manufactured by Tosoh Corporation) and calculated by gel permeation chromatography (GPC) in terms of polystyrene) and the acid value was 38.9 (mgKOH/g).

Next, 668.3 g of the obtained resin solution was weighed, and 388.3 g of isopropanol and 145.7 ml of aqueous 1 mol/L NaOH solution were added. Then, the temperature inside the reactor was raised to 80° C. Next, 720.1 g of distilled water was added dropwise at a rate of 20 ml/min so that the copolymer resin is dispersed in water. Thereafter, the resultant was held under an atmospheric pressure at a temperature inside the reactor of 80° C. for 2 hours, and then maintained at 85° C. for 2 hours, and then further maintained at 90° C. for 2 hours. Then, the pressure inside the reactor was reduced, and the isopropanol, methyl ethyl ketone, and distilled water were distilled off in the total amount of 913.7 g, to provide a water dispersion of a self-dispersible polymer particle P-2 having a solid content of 28.0 weight %. The numbers attached to the structural units represent mass ratio of the respective structural units.

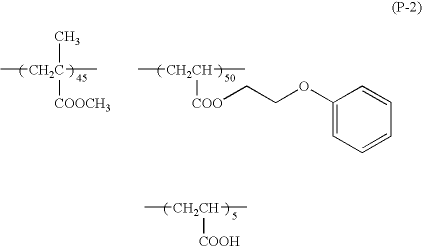

The colorant (the cyan dispersion liquid) obtained above, the first water-soluble organic solvent, the surfactant and water were mixed to have the final formulation described below. The obtained mixture was passed through a membrane filter having a pore size of 5 μm, whereby Ink-1 (inkjet recording liquid) was obtained.

Formulation of Ink-1

| | |
|---|---|
| Cyan pigment (pigment blue 15:3) | 3% |
| Polymer dispersant P-1 | 1.5% |
| Self-dispersible polymer particle P-2 | 6% |
| Dipropyerne glycol (DRG) | 15% |
| Surfactant (trade name: OLFINE E1010, | 1% |
| manufactured by Nissin Chemical | |
| Industry Co., Ltd.) | |
| Ion-exchanged water | 73.5% |

### Examples 2 to 12

Inks 2 to 10, 19 and 20 were prepared in a similar manner to Example 1 except that the kind and content amount of the first water-soluble organic solvent and the second water-soluble organic solvent (also referred to as the “other water-soluble organic solvent”) used in Example 1 were changed as shown in Table 1 below. However, the amount of thickening agent in both of inks 19 and 20 was set at 0.5% with respect to the total mass of the ink.

### Comparative Examples 1 to 10

Inks 11 to 18, 21 and 22 were prepared in a similar manner to Example 1 except that the kind and content amount of the first water-soluble organic solvent and the other water-soluble organic solvent used in Example 1 were changed as shown in Table 1 below.

Evaluation of Inkjet Recording Liquid

DIMATIX MATERIAL PRINTER DMP-2831 (trade name, manufactured by FUJIFILM Dimatix Inc.) that was equipped with a 10 pl ejection cartridge formed by modifying DMC-111610 (trade name, manufactured by FUJIFILM Dimatix Inc.) to allow liquid supply from the outside was used as an inkjet recording apparatus.

A colorless ink composition, which is a printability-improving liquid composition prepared by mixing the materials having the following formulation, was applied onto a sheet of TOKUBISHI ART RYOMEN N (trade name, manufactured by Mitsubishi Seishi Co., basis weight: 84.9 g/m²) with a coating bar so as to make the thickness of the coated film be about 5 g/m², and the coated film is subjected to drying at 60° C. with wind velocity of 15 m/s for 1 minute after the coating, so as to provide an image recording medium.

### Formulation of Colorless Ink Composition:

| | |
|---|---|
| Citric acid | 15 g |
| OLFINE E1010 (trade name, described above) | 1 g |
| Ion-exchanged water | 84 g |

Evaluation of Curling Property

A solid image was printed with any one of Ink-1 to Ink-22 on the recording medium in an ink coating amount of 5 g/m², dried, and cut to provide a strip of a sample having a size of 5 mm×50 mm such that when the strip curls, the curling direction would be the length direction (the side of 50 mm) of the strip. Then, after the sample strip was left to stand under the temperature of 35° C. and a relative humidity of 80%, the curvature C of the sample strip was measured in the following manner. The evaluation results of curling property in accordance with the following criteria are shown in Tables 1 to 3.

Method of Measuring Curvature

Curvature C of the sample on which the inkjet recording liquid had been applied was measured under conditions of a temperature of 25° C. and a relative humidity of 50%. Here, the curl of the sample was regarded as an arc of a circle with a radius of R, and the curl value was calculated according to the equality of C=1/R(m).

Evaluation Criteria

AA: Curvature C measured ten minutes after ink application did not exceed 20.

A: Curvature C measured ten minutes after ink application exceeded 20, but Curvature C measured one day after ink application did not exceed 20

B: Curvature C measured one day after ink application exceeded 20, but Curvature C seven days after ink application did not exceed 20

C: Curvature C measured after 7 days of ink application exceeded 20

Storage Stability

Each of the obtained inkjet recording liquids (Ink-1 to Ink-22) was evaluated as follows. The temperature of the inkjet recording liquid was adjusted to 25° C. The viscosity of the inkjet recording liquid (undiluted) at 25° C. was measured with an vibratory viscometer (trade name: DV-II+VISCOMETER, manufactured by BROOKFIELD) under conditions of a temperature of 25° C. and a relative humidity of 50% on a cone plate (φ35 mm). Measurement data were obtained in a torque range of from 20% to 90% and a revolution number range of from 0.5 rpm to 100 rpm, and the average value of the measurement data was used as a measured viscosity. The measured viscosity obtained from the inkjet recording liquid immediately after the preparation thereof was defined as “ink viscosity 1”.

Subsequently, a part of the inkjet recording liquid was placed in a sample bottle made of glass, and the bottle was sealed and left (stored) at 60° C. for 2 weeks. Thereafter, the viscosity of the inkjet recording liquid which was subjected to the 2 weeks-storage was measured in the same manner as described above, and the obtained value was defined as “ink viscosity 2”. Simultaneously, the state of the ink liquid was inspected by visual observation.

The ratio of change in the ink viscosity measured before and after storage was calculated by the following equation.

The ratio of change in the ink viscosity=100−((ink viscosity 2/ink viscosity 1)×100)

Ink storage stability was evaluated in accordance with the following evaluation criteria, also considering the result of the inspection by visual observation after storage. The results are shown in Tables 1 to 3.

Evaluation Criteria

AA: The rate of change in the ink viscosity was less than ±15%, and a change in the ink recording liquid was not observed.

A: The rate of change in the ink viscosity was ±15% or more but less than ±30%, and a change in the ink recording liquid was not observed.

B: The rate of change in the ink viscosity was ±30% or more but less than ±50%, and a change in the ink recording liquid was not observed.

C: The rate of change in the ink viscosity was ±50% or more, or separation or gelation of the ink recording liquid was observed.

TABLE 1

| | | | | | | | | | | | | | Amount | | |
|---|---|---|---|---|---|---|---|---|---|---|---|---|---|---|---|
| | | | | | | | | | | | | | of water- | | |
| | | | | | | | | | | | | | soluble | | |
| | | | | | | | | | | | | | organic | | |
| | | | | | | | | | | | | | solvent | Curling | |
| | | | | | | | | | | | | | with | at | |
| | | | | | | | | | | | | | SP < 27.5 | 35° C. | |
| | | First water-soluble organic solvent | | | | | Other water-soluble organic solvent | | | | | Total | and | and | Storage |
| | Ink | | | SP | Vis- | Solvent | | | SP | Vis- | Solvent | Solvent | viscosity | 80% | proper- |
| | No. | Solvent | Mw | value | cosity | amount*¹ | Solvent | Mw | value | cosity | amount*¹ | amount*¹ | ≦100*² | RH | ties |
| Example 1 | 1 | DPG | 134.2 | 27.14 | 75 | 15% | — | — | — | — | — | 15% | 100% | AA | AA |
| Example 2 | 2 | DPG | 134.2 | 27.14 | 75 | 20% | — | — | — | — | — | 20% | 100% | A | AA |
| Example 3 | 3 | TEGmBE | 206.3 | 21.11 | 8.1 | 20% | — | — | — | — | — | 20% | 100% | AA | A |
| Example 4 | 4 | TEGmEE | 178.3 | 21.73 | 6.8 | 20% | — | — | — | — | — | 20% | 100% | A | A |
| Example 5 | 5 | TPGmME | 206.3 | 20.4 | 5.8 | 20% | — | — | — | — | — | 20% | 100% | AA | AA |
| Example 6 | 6 | TPGmME | 206.3 | 20.4 | 5.8 | 25% | — | — | — | — | — | 25% | 100% | A | A |
| Example 7 | 7 | DEGmEE | 134.2 | 22.4 | 4.3 | 25% | — | — | — | — | — | 25% | 100% | AA | A |
| Example 8 | 8 | TEGmME | 164.2 | 22.1 | 6.4 | 25% | — | — | — | — | — | 25% | 100% | A | A |
| Example 9 | 9 | DPG | 134.2 | 27.14 | 75 | 19% | POP(3) | 250 | 26.4 | 900 | 6% | 25% | 72% | A | AA |
| | | | | | | | glyceryl | | | | | | | | |
| Exam- | 10 | DPG | 134.2 | 27.14 | 75 | 19% | DEG | 106 | 30.6 | 32 | 6% | 25% | 72% | A | AA |
| ple 10 | | | | | | | | | | | | | | | |

TABLE 2

| | | | | | | | | | | | | | Amount | | |
|---|---|---|---|---|---|---|---|---|---|---|---|---|---|---|---|
| | | | | | | | | | | | | | of | | |
| | | | | | | | | | | | | | water- | | |
| | | | | | | | | | | | | | soluble | | |
| | | | | | | | | | | | | | organic | | |
| | | | | | | | | | | | | | solvent | Curling | |
| | | | | | | | | | | | | | with | at | |
| | | | | | | | | | | | | | SP < 27.5 | 35° C. | |
| | | First water-soluble organic solvent | | | | | Other water-soluble organic solvent | | | | | Total | and | and | |
| | Ink | | | SP | Vis- | Solvent | | | SP | Vis- | Solvent | Solvent | viscosity | 80% | Storage |
| | No. | Solvent | Mw | value | cosity | amount*¹ | Solvent | Mw | value | cosity | amount*¹ | amount*¹ | ≦100*² | RH | properties |
| Comp. | 11 | DPG | 134.2 | 27.14 | 75 | 16% | POP(3) | 250 | 26.4 | 900 | 9% | 25% | 64% | B | AA |
| example 1 | | | | | | | glyceryl | | | | | | | | |
| Comp. | 12 | — | — | — | — | — | POP(3) | 250 | 26.4 | 900 | 25% | 25% | 0% | C | AA |
| example 2 | | | | | | | glyceryl | | | | | | | | |
| Comp. | 13 | DPG | 134.2 | 27.14 | 75 | 16% | DEG | 106 | 30.6 | 32 | 9% | 25% | 64% | B | AA |
| example 3 | | | | | | | | | | | | | | | |
| Comp. | 14 | — | — | — | — | — | DEG | 106 | 30.6 | 32 | 25% | 25% | 0% | C | AA |
| example 4 | | | | | | | | | | | | | | | |
| Comp. | 15 | DPG | 134.2 | 27.14 | 75 | 35% | — | — | — | — | — | 35% | 100% | B | A |
| example 5 | | | | | | | | | | | | | | | |
| Comp. | 16 | DPG | 134.2 | 27.14 | 75 | 45% | — | — | — | — | — | 45% | 100% | C | B |
| example 6 | | | | | | | | | | | | | | | |
| Comp. | 17 | DPG | 134.2 | 27.14 | 75 | 3% | — | — | — | — | — | 3% | 100% | B | AA |
| example 7 | | | | | | | | | | | | | | | |
| Comp. | 18 | — | — | — | — | — | GP- | 250.0 | 26.38 | 900 | 15% | 15% | 100% | C | AA |
| example 8 | | | | | | | 250 | | | | | | | | |

TABLE 3

| | | | | | | | | | | | | | Amount | | |
|---|---|---|---|---|---|---|---|---|---|---|---|---|---|---|---|
| | | | | | | | | | | | | | of water- | | |
| | | | | | | | | | | | | | soluble | | |
| | | | | | | | | | | | | | organic | | |
| | | | | | | | | | | | | | solvent | Curling | |
| | | | | | | | | | | | | | with | at | Stor- |
| | | | | | | | | | | | | | SP < 27.5 | 35° C. | age |
| | | First water-soluble organic solvent | | | | | Other water-soluble organic solvent | | | | | Total | and | and | prop- |
| | Ink | | | SP | Vis- | Solvent | | | SP | Vis- | Solvent | Solvent | viscosity | 80% | er- |
| | No. | Solvent | Mw | value | cosity | amount*¹ | Solvent | Mw | value | cosity | amount*¹ | amount*¹ | ≦100*² | RH | ties |
| Exam- | 19 | DPG | 134.2 | 27.14 | 75 | 15% | Thickener | 20000 | — | — | — | 15% | 100% | AA | AA |
| ple | | | | | | | PEG20000 | | | | | | | | |
| 11 | | | | | | | | | | | | | | | |
| Exam- | 20 | DPG | 134.2 | 27.14 | 75 | 15% | Thickener | 20000 | — | — | — | 15% | 100% | AA | A |
| ple | | | | | | | PVA205 | | | | | | | | |
| 12 | | | | | | | | | | | | | | | |
| Comp. | 21 | — | — | — | — | — | Triethylene | 150.2 | 27.79 | 43 | 15% | 15% | 0% | C | AA |
| exam- | | | | | | | glycol | | | | | | | | |
| ple 9 | | | | | | | (TEG) | | | | | | | | |
| Comp. | 22 | — | — | — | — | — | GP-400 | 400.0 | 23.15 | 360 | 15% | 15% | 0% | B | A |
| exam- | | | | | | | | | | | | | | | |
| ple | | | | | | | | | | | | | | | |
| 10 | | | | | | | | | | | | | | | |

*¹The “solvent amount” and the “total Solvent amount” are respectively expressed in terms of its ratio (percentage) with respect to the total amount of the ink.

It is evident from Tables 1 to 3 that the inkjet recording liquid of the present invention exhibits a favorable curling suppression effect and has superior ink storage properties.

All publications, patent applications, and technical standards mentioned in this specification are herein incorporated by reference to the same extent as if such individual publication, patent application, or technical standard was specifically and individually indicated to be incorporated by reference.

What is claimed is:

1. An inkjet recording liquid, comprising:
water;
a colorant; and
one or more water-soluble organic solvents,
the one or more water-soluble organic solvents comprising a water-soluble organic solvent having a viscosity of no more than 100 mPa·s at 25° C. and a solubility parameter value of less than 27.5 at a content of at least 70 weight % with respect to the total content of the one or more water-soluble organic solvents, and
the total content of the water-soluble organic solvent having a viscosity of no more than 100 mPa·s at 25° C. and a solubility parameter value of less than 27.5 being from 5 mass % to less than 30 mass % with respect to the total amount of the inkjet recording liquid.

2. The inkjet recording liquid of claim 1, wherein the colorant is a pigment, and the pigment is dispersed by a phase-inversion emulsification method.

3. The inkjet recording liquid of claim 1, further comprising self-dispersing polymer particles.

4. The inkjet recording liquid of claim 1, further comprising a water-soluble polymer thickener having a molecular weight of from 2,000 to 100,000.
